(19) United States
(12) Patent Application Publication
(10) Pub. No.: US 2013/0286658 A1
(43) Pub. Date: Oct. 31, 2013

(54) LIGHT EMITTING DIODE

(71) Applicants: CHIN-CHUNG CHEN, Tu-Cheng (TW); SHAN-YUE WANG, Foshan City (CN)

(72) Inventors: CHIN-CHUNG CHEN, Tu-Cheng (TW); SHAN-YUE WANG, Foshan City (CN)

(21) Appl. No.: 13/653,635

(22) Filed: Oct. 17, 2012

(30) Foreign Application Priority Data
Apr. 28, 2012 (CN) 201210130418.5

(51) Int. Cl. F21V 13/04

(52) U.S. Cl. 362/308; 362/327

(57) ABSTRACT

An exemplary lens includes a periphery acting as a light output surface of the lens, a light input surface surrounded by the light output surface, and a reflecting surface recessed downwardly towards the light input surface and surrounded by the light output surface. A top end of the reflecting surface connects with the light output surface.

The reflecting surface extends downwardly and inwardly from top to bottom. Light emitted from the light source travels into the lens from the light input surface; a part of the light directly travels out the lens from the light output surface, and the other part of the light is arrived to the reflecting surface and reflected back to the lens by the reflecting surface and travels out the lens from the light output surface.

### BACKGROUND

1. Technical Field

The disclosure generally relates to light sources, and more particularly to a light emitting diode (LED) having a secondary optical element which can increase light intensity of light from an LED chip at a lateral direction whereby the LED can have a wider range of illumination.

2. Description of Related Art

LEDs have many beneficial characteristics, including low electrical power consumption, low heat generation, long lifetime, small volume, good impact resistance, fast response and excellent stability. These characteristics have enabled the LEDs to be widely used as a light source in electrical appliances and electronic devices.

A conventional LED generally generates a smooth round light field with a radiation angle of 120 degrees (±60 degrees). The light emitted from the LED is mainly concentrated at a center thereof. The light at a periphery of the LED is relatively poor and can not be used to illuminate. Therefore, the LED cannot be used in a lamp which requires a wide illumination rage, for example, an explosion-proof lamp which may be a safety miner's cap lamp or a gas station canopy

What is needed, therefore, is an improved LED which overcomes the above described shortcomings

### BRIEF DESCRIPTION OF THE DRAWINGS

FIG. 1 is a cross-sectional view of an LED according to an exemplary embodiment of the present disclosure.

FIG. 2 is an isometric view of the LED of FIG. 1.

FIG. 3 is an inverted view of the LED of FIG. 2.

FIG. 4 is a front view showing light paths of the LED of FIG. 2.

FIG. 5 is a luminous intensity curve graph of the LED of the present disclosure.

### DETAILED DESCRIPTION

An embodiment of an LED in accordance with the present disclosure will now be described in detail below and with reference to the drawings.

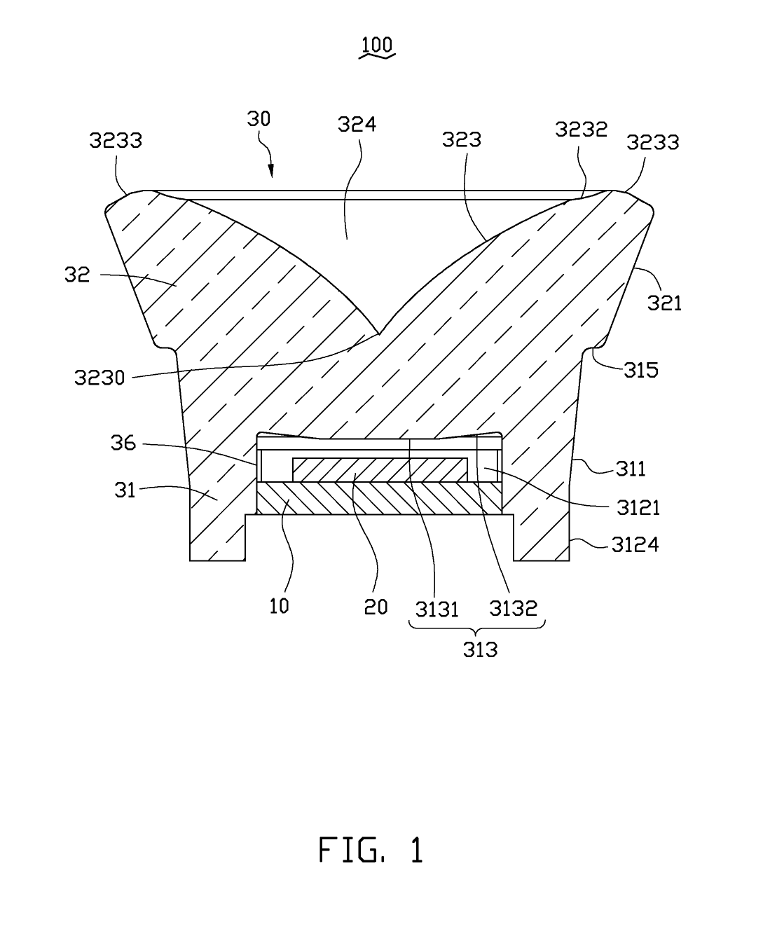

Referring to FIG. 1, an LED 100 in accordance with an exemplary embodiment of the disclosure includes a base 10, an LED chip 20 mounted on the base 10 and a lens 30 covering the LED chip 20 and engaging with the base 10.

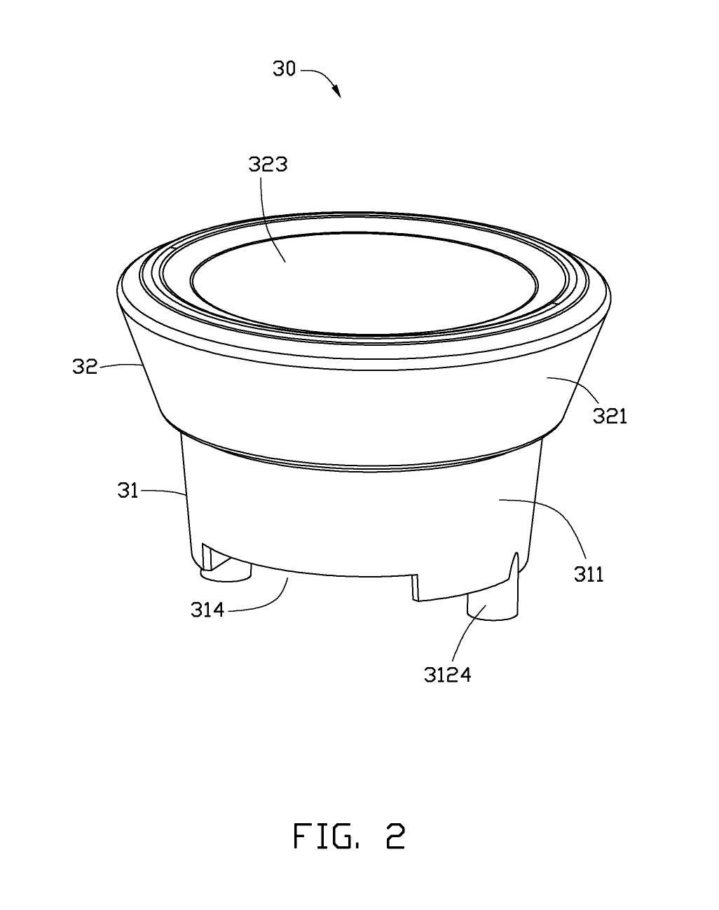

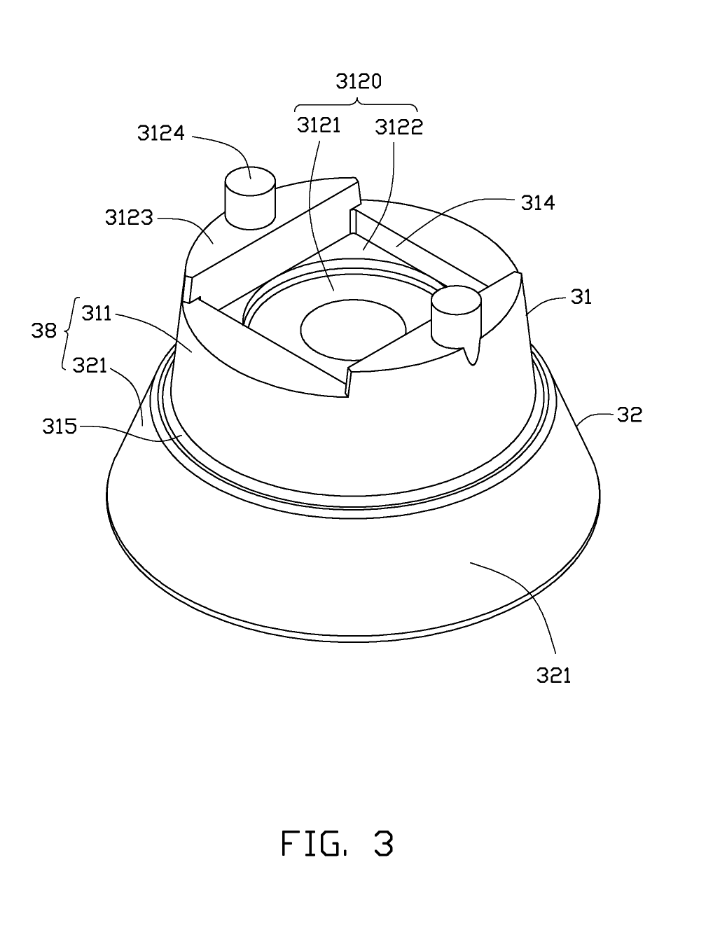

Referring to FIGS. 2-3, the lens 30 includes an engaging portion 31 and an extending portion 32 extending from a top end of the engaging portion 31. The engaging portion 31 and the extending portion 32 are integrally formed and coaxial. The lens 30 is made of a material with high light transmittance, for example, glass, PMMA (poly ethylinethacrylate) or PC (polycarbonate).

The engaging portion 31 is cylindrical. A periphery of the engaging portion 31 is a first light output surface 311 of the lens 30. A diameter of the engaging portion 31 increases from a bottom surface 312 of the engaging portion 31 to the top end thereof, which connects with the extending portion 32.

A receiving chamber 3120 is recessed from a center of a bottom surface 312 of the engaging portion 31 to receive the base 10 therein. From top to bottom, the receiving chamber 3120 includes a first receiving part 3121 and a second receiving part 3122 communicating with the first receiving part 3121. The first receiving part 3121 is annular to receive the LED chip 20 therein. The second receiving part 3122 is square to receive the base 10 therein. A width of the second receiving part 3122 is similar to a diameter of the first receiving part 3121. The first receiving part 3121 and the second receiving part 3122 are coaxial. A top edge 313 of the first receiving part 3121 includes a first light input part 3131 and a second light input part 3132 enclosing the first light input part 3131. The first light input part 3131 is circular. The second light input part 3132 is annular and extends outwardly and upwardly from an outer periphery of the first light input part 3131. The top edge 313, an inner surface of the first receiving part 3121, and an inner surface of the second receiving part 3122 cooperatively form a light input surface 36 of the lens 30 to guide light generated by the LED chip 20 to enter the lens 30.

Two protrusions 3123 extend downwardly from opposite sides of the bottom surface 312 and are spaced from each other. Each protrusion 3123 has an arc-shaped outer surface and a rectangular, flat inner surface opposite to the outer surface. The outer surfaces of the protrusions 3123 are coplanar to the first light output surface 311. The inner surfaces of the protrusions 3123 are parallel to and spaced from each other. A cutout 314 is defined between the protrusions 3123 to guide the base 10 into the second receiving part 3122. Two poles 3124 each extend downwardly from a center of a bottom surface of a corresponding protrusions 3123. Each pole 3124 is a cylinder for engaging in a substrate, such as a printed circuit board (not shown) to mount the lens 30 on the printed circuit board.

The extending portion 32 is a frustum. A diameter of the extending portion 32 increases from a bottom end connecting the engaging portion 31 to a top end away from the engaging portion 31. A periphery of the extending portion 32 is a second light output surface 321 of the lens 30. The bottom end of the extending portion 32 is larger than the top end of the engaging portion 31. A step 315 is formed at a joint of the top end of the engaging portion 31 and the bottom end of the extending portion 32. The first light output surface 311 and the second light output surface 321 cooperatively form a light output surface 38 of the lens 30.

A central portion of the top end of the extending portion 32 is recessed to define a groove 324 therein. The groove 324 has a bottom point 3230 aligned with a center of the first input part 3131. The lens 30 is symmetrical about a central axis of the lens 30, wherein the central axis of the lens 30 extends through the bottom point 3230 and the center of first input part 3131. The groove 324 is funneled and a bore diameter thereof generally increases from the bottom point 3230 to a top end thereof away from the bottom point 3230. A top surface of the lens 30 defining the groove 324 is a reflecting surface 323 which reflects most of light impinging on the reflecting surface 323 to the light output surface 38. As clearly shown in FIG. 1, a profile of a section of the reflecting surface 323 beside the bottom point 3230 is curved and convex upwardly and inwardly. A cross section of the reflecting surface 323 is generally V-shaped. A curvature of the convex of the reflecting surface 323 is varied between 0.0642 to 0.1920.

A transition surface 3232 is formed on the top end of the groove 324 and an inner edge thereof connects a top edge of the reflecting surface 323. The transition surface 3232 extends upwardly and outwardly from the top edge of the reflecting surface 323. A connecting surface 3233 smoothly connects the transition surface 3232 and the second light output surface 321. The reflecting surface 323, the transition surface 3232, and the connecting surface 3233 are reflective. A reflective material can be coated on the reflecting, transition and connect surfaces 323, 3232, 3233, whereby a light reflectivity of these surfaces is larger than a light perviousness thereof. .

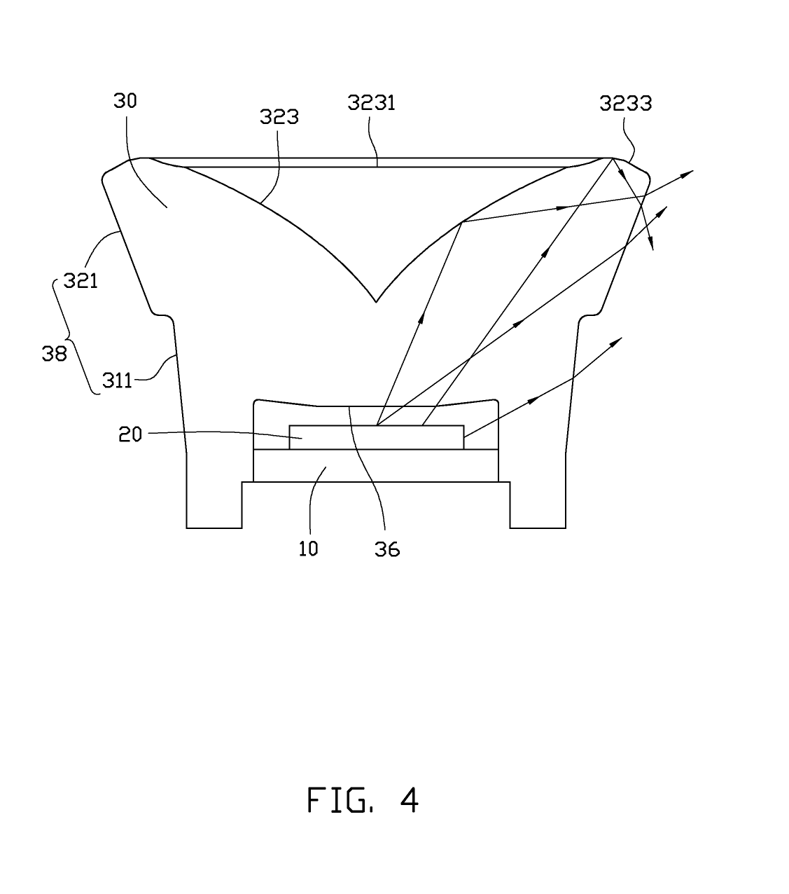

Referring to FIG. 4, during operation of the LED 100, light emitted from the LED chip 20 travels into the lens 30 from the light input surface 36 of the lens 30. A part of the light is arrived at the first light output surface 311 and the second light output surface 321 and directly travels out of the lens 30, and another part of the light is arrived at the reflecting surface 323, the transition surface 3232 and the connecting surface 3233.

Most of the another part of the light is reflected by the reflecting surface 323, the transition surface 3232 and the connecting surface 3233 and travels towards the first light output surface 311 and the second light output surface 321 to radiate therefrom to leave the lens 30. Thus, the LED 100 has a radiation angle more than 120 degrees.

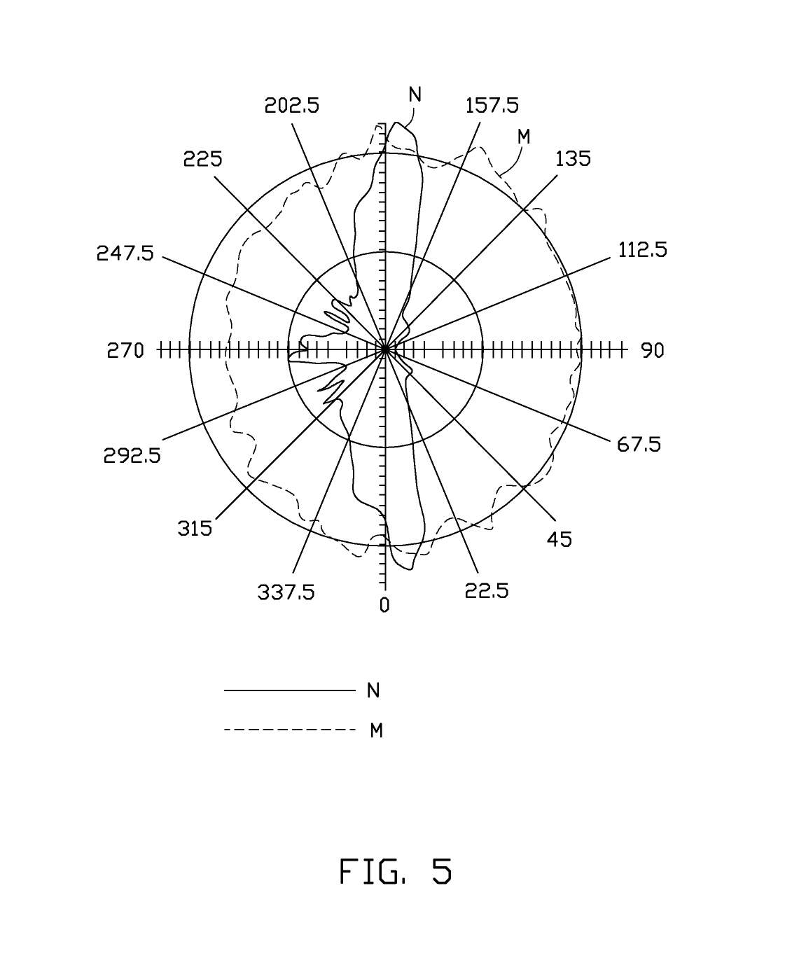

Referring to FIG. 5, an illumination intensity distribution of the LED 100 is shown wherein an N line shows a luminous intensity curve as viewed from the front side of the LED 100, while an M line shows a luminous intensity curve as viewed from a top view of the LED 100 which is perpendicular to viewing aspect of the N line. The M line shows that light is evenly distributed at a surface perpendicular to the central axis of the LED and forms a similar circular projection. The N line shows the radiation of the LED 100 is larger than 180 degrees. About 90% light emitted from the LED 100 is distributed in a region between 170° to 190°, and only a small light is distributed in a region between 10° to 160°; thus, a light intensity at a lateral side of the LED 100 is enhanced and an illumination range of the LED 100 is increased.

It is to be further understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A lens adapted for adjusting light emitted from a light source whereby light intensity at a lateral side of the light source is increased, the lens comprising:
a periphery acting as a light output surface of the lens from which the light entering the lens leaves the lens;
a light input surface surrounded by the light output surface, configured for receiving the light from the light source; and
a reflecting surface recessed downwardly towards the light input surface and surrounded by the light output surface, a top end of the reflecting surface connecting the light output surface, a bottom end of the reflecting surface located over a center of the light input surface, the reflecting surface extending downwardly and inwardly from the top end to the bottom end, a light reflectivity of the reflecting surface being larger than a light perviousness thereof;
wherein the light emitted from the light source travels into the lens from the light input surface, a part of the light directly travels out the lens from the light output surface, and the other part of the light is arrived to the reflecting surface and reflected back to the lens by the reflecting surface and travels out the lens from the light output surface.

2. The lens of claim 1, wherein a groove is defined in a top end of the lens, and a top surface of the lens defining the groove forms the reflecting surface of the lens.

3. The lens of claim 2, wherein the groove is funneled and a bore diameter thereof generally increases from bottom to top.

4. The lens of claim 3, wherein a profile of a section of the reflecting surface beside the bottom end of the reflecting surface is curved and convex inwardly and upwardly.

5. The lens of claim 3, wherein a curvature of the profile of the section of the reflecting surface is varied between 0.0642 and 0.1920.

6. The lens of claim 3, wherein a transition surface extends upwardly and outwardly from the top edge of the reflecting surface and a connecting surface smoothly connects the transition surface and a top end of the light output surface.

7. The lens of claim 1, wherein the lens comprises an engaging portion and an extending portion extending from a top end of the engaging portion, the engaging portion and the extending portion are integrally formed and coaxial.

8. The lens of claim 7, wherein a periphery of the engaging portion and a periphery of the extending portion cooperatively form the light output surface of the lens.

9. The lens of claim 8, wherein the extending portion is a frustum and a diameter of the extending portion increases from a bottom end connecting the engaging portion to a top end away from the engaging portion.

10. The lens of claim 9, wherein the bottom end of the extending portion is larger than the top end of the engaging portion, and a step is formed at a joint of the top end of the engaging portion and the bottom end of the extending portion.

11. The lens of claim 9, wherein the reflecting surface is defined in a central portion of the top end of the extending portion.

12. The lens of claim 7, wherein the engaging portion is cylindrical, and a diameter of the engaging portion increases from a bottom end away from the extending portion to the top end connecting the extending portion.

13. The lens of claim 12, wherein a receiving chamber is defined in the bottom end of the engaging portion, and an inner periphery of the receiving chamber is the light input surface of the lens.

14. The lens of claim 12, wherein two protrusions extend downwardly from opposite sides of the bottom end of the engaging portion and spaced from each other to define a cutout therebetween, the cut being configured for guiding the light source into the receiving chamber.

15. The lens of claim 14, wherein two poles extend downwardly from the protrusions respectively, the two poles being configured for engaging in a mounting device.

16. An LED comprising:
a base;
an LED chip mounted on base; and
a lens covering the LED chip and engaging with the base, the lens comprising a periphery acting as a light output surface of the lens, a light input surface surrounded by the light output surface, and a reflecting surface recessed downwardly towards the light input surface and surrounded by the light output surface, a top end of the reflecting surface connecting the light output surface, a bottom end of the reflecting surface being located over a top of the light input surface, the reflecting surface extending downwardly and inwardly from the top end to the bottom end, a light reflectivity of the reflecting surface larger than a light perviousness thereof;
wherein light emitted from the LED chip travels into the lens from the light input surface, a part of the light directly travels out the lens from the light output surface, and the other part of the light is arrived to the reflecting surface and reflected back to the lens by the reflecting surface and travels out the lens from the light output surface.

17. The lens of claim 16, wherein the reflecting surface is funneled and a bore diameter of the funnel generally increases from bottom to top.

18. The lens of claim 17, wherein a profile of a section of the light reflecting surface beside the bottom end is curved and convex inwardly and upwardly and a curvature of the profile of the section of the reflecting surface is varied between 0.0642 and 0.1920.

19. The lens of claim 16, wherein a receiving chamber is defined in a bottom end of the lens, and the LED chip and the base are received in the receiving chamber.

20. The lens of claim 19, wherein an inner periphery of the receiving chamber is the light input surface of the lens.
